(19) United States
(12) Patent Application Publication
(10) Pub. No.: US 2004/0021688 A1
(43) Pub. Date: Feb. 5, 2004

(54) Graphical user interface toolkit for generating swing screens

(75) Inventor: Brent Russel Phillips, Austin, TX (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY

(21) Appl. No.: 10/210,362

(22) Filed: Jul. 31, 2002

(51) Int. Cl. G09G 5/00

(52) U.S. Cl. 345/762; 345/764

(57) ABSTRACT

A graphical user interface toolkit is provided that gives developers a plurality of screen generation methods and prebuild instance variables that help with the creation of graphical user interface screens. The toolkit contains methods to store screen components by key, which allows and easy way to set information in each screen. The toolkit inherits the Abstract Window Toolkit and Swing classes. When an application class inherits the toolkit, these screen generation methods may be used to more quickly and easily generate graphical user interface screens. The application class may also call the methods in the Abstract Window Toolkit and Swing classes.

### BACKGROUND OF THE INVENTION

1. Technical Field:

The present invention relates to data processing and, in particular, to generating graphical user interface screen objects. Still more particularly, the present invention provides an improved graphical user interface toolkit for generating screen objects.

2. Description of Related Art:

Java is a programming language designed to generate applications that can run on all hardware platforms without modification. Java programs can be called from within HyperText Markup Language (HTML) documents or launched stand alone. Java is an interpreted language. The source code of a Java program is compiled into an intermediate language called “bytecode,” which cannot run by itself. The bytecode must be converted (interpreted) into machine code at runtime by invoking a Java interpreter (Java Virtual Machine (JVM)), which translates the bytecode into machine code and runs it. This means Java programs are not dependent on any specific hardware and will run in any computer with the Java Virtual Machine software.

A Java Runtime Environment (JRE) is the combination of the Java Virtual Machine, core classes, and supporting files, all of which are required to run a Java program. Abstract Window Toolkit (AWT) is a class library that provides an application framework and graphical user interface (GUI) routines for Java programmers.

Swing is a Java toolkit for developing GUIs. Swing includes elements such as menus, toolbars and dialog boxes. Swing is included in the Java Foundation Classes (JFC) which are provided in the Java Developers Toolkit (JDK).

In Java, there are limitations when developing in Swing. There are some basic tools available in the form of layout managers; however, these tools are cumbersome to use. The current tools in the JRE are primitive and require a lot of time and effort to use.

Therefore, it would be advantageous to provide an improved graphical user interface toolkit for generating screen objects.

### SUMMARY OF THE INVENTION

The present invention provides a graphical user interface toolkit that gives developers a plurality of screen generation methods and prebuild instance variables that help with the creation of graphical user interface screens. The toolkit contains methods to store screen components by key, which allows and easy way to set information in each screen. The toolkit inherits the Abstract Window Toolkit and Swing classes. When an application class inherits the toolkit, these screen generation methods may be used to more quickly and easily generate graphical user interface screens. The application class may also call the methods in the Abstract Window Toolkit and Swing classes.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a data processing system in which the present invention may be implemented in accordance with a preferred embodiment of the present invention;

FIG. 2 is a block diagram of a data processing system in which the present invention may be implemented;

FIG. 3 is a block diagram illustrating a software configuration for screen generation in accordance with a preferred embodiment of the present invention;

FIG. 4 is a diagram illustrating an example class structure for screen generation in accordance with a preferred embodiment of the present invention;

FIGS. 5A-5C are example screenshots of screens that may be generated using the GUI toolkit of the present invention;

FIGS. 6A and 6B depict example code for creating a border in accordance with a preferred embodiment of the present invention;

FIGS. 7A-7E depict example code for using an array list of components or a hash table in accordance with a preferred embodiment of the present invention;

FIGS. 8A and 8B depict example code for generating check boxes in accordance with a preferred embodiment of the present invention;

FIGS. 9A-9D illustrate example code for creating a group of radio buttons in accordance with a preferred embodiment of the present invention;

FIGS. 10A-10I illustrate example code for creating a screen panel in accordance with a preferred embodiment of the present invention; and

FIG. 11 is a flowchart illustrating the operation of the GUI toolkit receiving a method call is shown in accordance with the preferred embodiment of the present invention.

### DETAILED DESCRIPTION OF THE PREFERRED EMBODIMENT

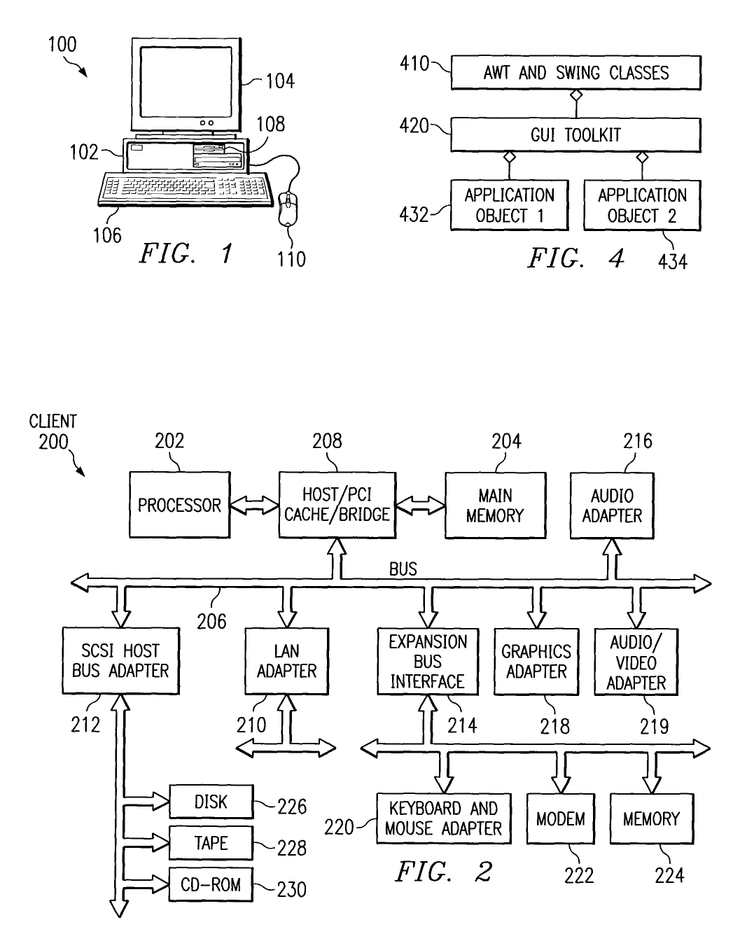

With reference now to the figures and in particular with reference to FIG. 1, a pictorial representation of a data processing system in which the present invention may be implemented is depicted in accordance with a preferred embodiment of the present invention. A computer 100 is depicted which includes system unit 102, video display terminal 104, keyboard 106, storage devices 108, which may include floppy drives and other types of permanent and removable storage media, and mouse 110. Additional input devices may be included with personal computer 100, such as, for example, a joystick, touchpad, touch screen, trackball, microphone, and the like. Computer 100 can be implemented using any suitable computer, such as an IBM eServer computer or IntelliStation computer, which are products of International Business Machines Corporation, located in Armonk, N.Y. Although the depicted representation shows a computer, other embodiments of the present invention may be implemented in other types of data processing systems, such as a network computer. Computer 100 also preferably includes a graphical user interface (GUI) that may be implemented by means of systems software residing in computer readable media in operation within computer 100.

With reference now to FIG. 2, a block diagram of a data processing system is shown in which the present invention may be implemented. Data processing system 200 is an example of a computer, such as computer 100 in FIG. 1, in which code or instructions implementing the processes of the present invention may be located. Data processing system 200 employs a peripheral component interconnect (PCI) local bus architecture. Although the depicted example employs a PCI bus, other bus architectures such as Accelerated Graphics Port (AGP) and Industry Standard Architecture (ISA) may be used. Processor 202 and main memory 204 are connected to PCI local bus 206 through PCI bridge 208. PCI bridge 208 also may include an integrated memory controller and cache memory for processor 202. Additional connections to PCI local bus 206 may be made through direct component interconnection or through add-in boards.

In the depicted example, local area network (LAN) adapter 210, small computer system interface SCSI host bus adapter 212, and expansion bus interface 214 are connected to PCI local bus 206 by direct component connection. In contrast, audio adapter 216, graphics adapter 218, and audio/video adapter 219 are connected to PCI local bus 206 by add-in boards inserted into expansion slots. Expansion bus interface 214 provides a connection for a keyboard and mouse adapter 220, modem 222, and additional memory 224. SCSI host bus adapter 212 provides a connection for hard disk drive 226, tape drive 228, and CD-ROM drive 230. Typical PCI local bus implementations will support three or four PCI expansion slots or add-in connectors.

An operating system runs on processor 202 and is used to coordinate and provide control of various components within data processing system 200 in FIG. 2. The operating system may be a commercially available operating system such as Windows XP, which is available from Microsoft Corporation. An object oriented programming system such as Java may run in conjunction with the operating system and provides calls to the operating system from Java programs or applications executing on data processing system 200. “Java” is a trademark of Sun Microsystems, Inc. Instructions for the operating system, the object-oriented programming system, and applications or programs are located on storage devices, such as hard disk drive 226, and may be loaded into main memory 204 for execution by processor 202.

Those of ordinary skill in the art will appreciate that the hardware in FIG. 2 may vary depending on the implementation. Other internal hardware or peripheral devices, such as flash read-only memory (ROM), equivalent nonvolatile memory, or optical disk drives and the like, may be used in addition to or in place of the hardware depicted in FIG. 2. Also, the processes of the present invention may be applied to a multiprocessor data processing system.

For example, data processing system 200, if optionally configured as a network computer, may not include SCSI host bus adapter 212, hard disk drive 226, tape drive 228, and CD-ROM 230. In that case, the computer, to be properly called a client computer, includes some type of network communication interface, such as LAN adapter 210, modem 222, or the like. As another example, data processing system 200 may be a stand-alone system configured to be bootable without relying on some type of network communication interface, whether or not data processing system 200 comprises some type of network communication interface. As a further example, data processing system 200 may be a personal digital assistant (PDA), which is configured with ROM and/or flash ROM to provide non-volatile memory for storing operating system files and/or user-generated data.

The depicted example in FIG. 2 and above-described examples are not meant to imply architectural limitations. For example, data processing system 200 also may be a notebook computer or hand held computer in addition to taking the form of a PDA. Data processing system 200 also may be a kiosk or a Web appliance.

The processes of the present invention are performed by processor 202 using computer implemented instructions, which may be located in a memory such as, for example, main memory 204, memory 224, or in one or more peripheral devices 226-230.

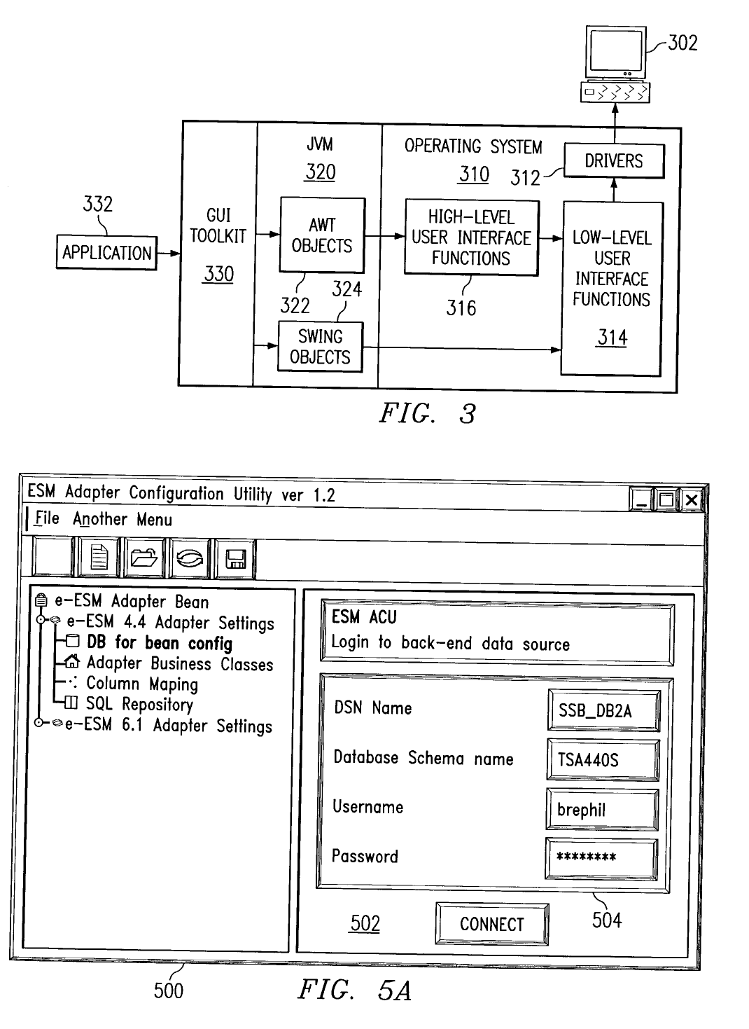

With reference now to FIG. 3, a block diagram illustrating a software configuration for screen generation is shown in accordance with a preferred embodiment of the present invention. The software configuration includes operating system 310 and Java Virtual Machine (JVM) 320.

Operating system 310 includes drivers 312, low-level user interface functions 314, and high-level user interface functions 316. The low-level user interface functions communicate with drivers 312 to display text and graphics on display 302. The high-level user interface functions call the low-level user interface functions.

JVM 320 is software code that converts Java intermediate code, also referred to as bytecode, and executes it on operating system 310. The JVM includes core classes and supporting files that are required to run a Java program. These classes include Abstract Window Toolkit (AWT) objects 322 and Swing objects 324. AWT is a class library that provides an application framework and graphical user interface (GUI) routines for Java programmers. The AWT objects use high-level user interface functions 316. Swing is a Java toolkit for developing GUIs. Swing includes elements such as menus, toolbars and dialog boxes. The Wing objects use low-level user interface functions 314.

An application running in the Java Runtime Environment may call AWT objects 322 and Swing objects 324. An application may also include platform-specific instructions that may use low-level user interface functions 314 and high-level user interface functions 316.

In Java, there are limitations when developing in Swing. There are some basic tools available in the form of layout managers; however, these tools are cumbersome to use. The current tools in the JRE are primitive and require a lot of time and effort to use.

In accordance with a preferred embodiment of the present invention, graphical user interface (GUI) toolkit 330 is provided. The GUI toolkit gives developers a plurality of screen generation methods and prebuild instance variables that help with the creation of graphical user interface screens. The toolkit contains methods to store screen components by key, which allows and easy way to set information in each screen.

The GUI toolkit inherits the Abstract Window Toolkit 322 and Swing classes 324. When an application class, such as application 332, inherits GUI toolkit 330, these screen generation methods may be used to more quickly and easily generate graphical user interface screens. The application class may also call the methods in AWT objects 322 and Swing objects 324 directly.

With reference now to FIG. 4, a diagram illustrating an example class structure for screen generation is shown in accordance with a preferred embodiment of the present invention. GUI toolkit class 410 inherits AWT and Swing classes 420. Thus, the GUI toolkit inherits the properties of and can call the methods of these classes.

Application object 432 and 434 inherit the GUI toolkit class. Thus, objects 432 and 434 inherit the properties of and can call the methods of the GUI toolkit class. In addition, objects 432 and 434 can call the methods of the AWT and Swing classes.

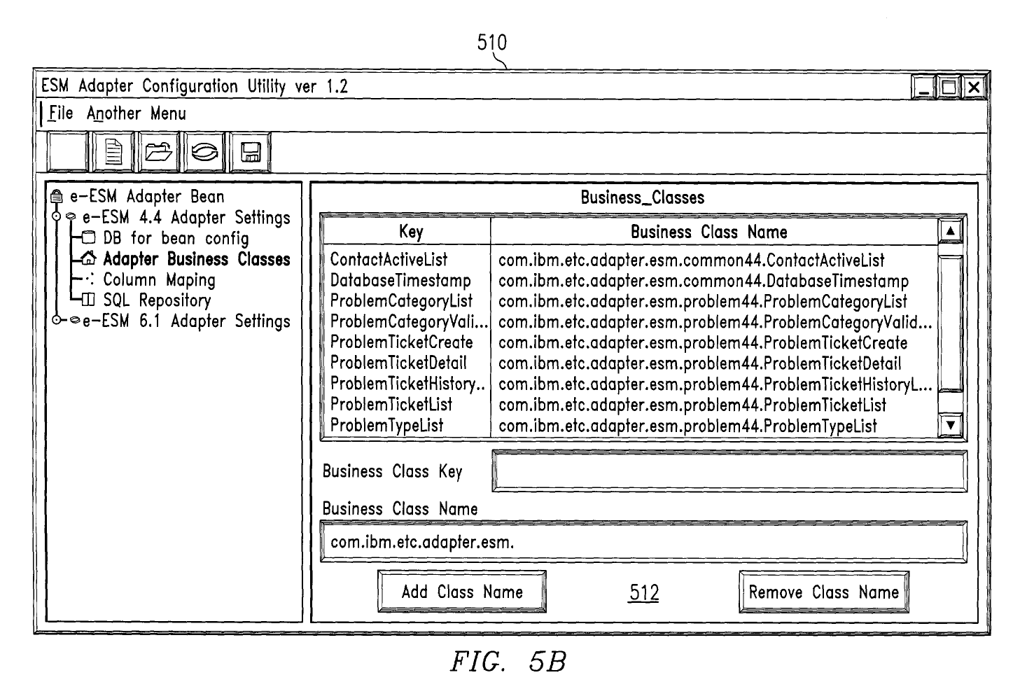

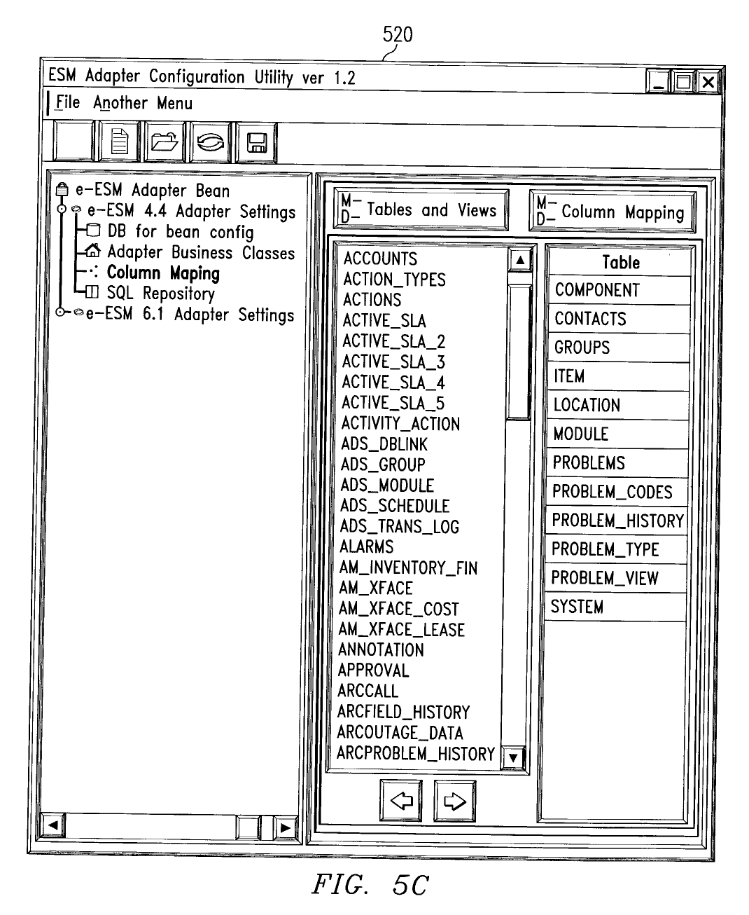

FIGS. 5A-5C are example screenshots of screens that may be generated using the GUI toolkit of the present invention. More particularly, with reference to FIG. 5A, screen 500 includes screen components that may be generated using the GUI toolkit. These screen components include buttons, text fields, menus, and the like.

Specifically, screen 500 includes panel 502 that may be generated using the GUI toolkit. Furthermore, panel 502 includes border 504. Other screen components may be generated more simply by calling the AWT and Screen classes directly.

Turning now to FIG. 5B, screen 510 includes other screen components that may be generated using the GUI toolkit. More specifically, screen 510 includes border 512, which also displays a title string. FIG. 5C illustrates screen 520, which includes panel 522. In this example, panel 522 has multiple columns of components. This panel may be created more easily with the GUI toolkit than with the Swing objects directly.

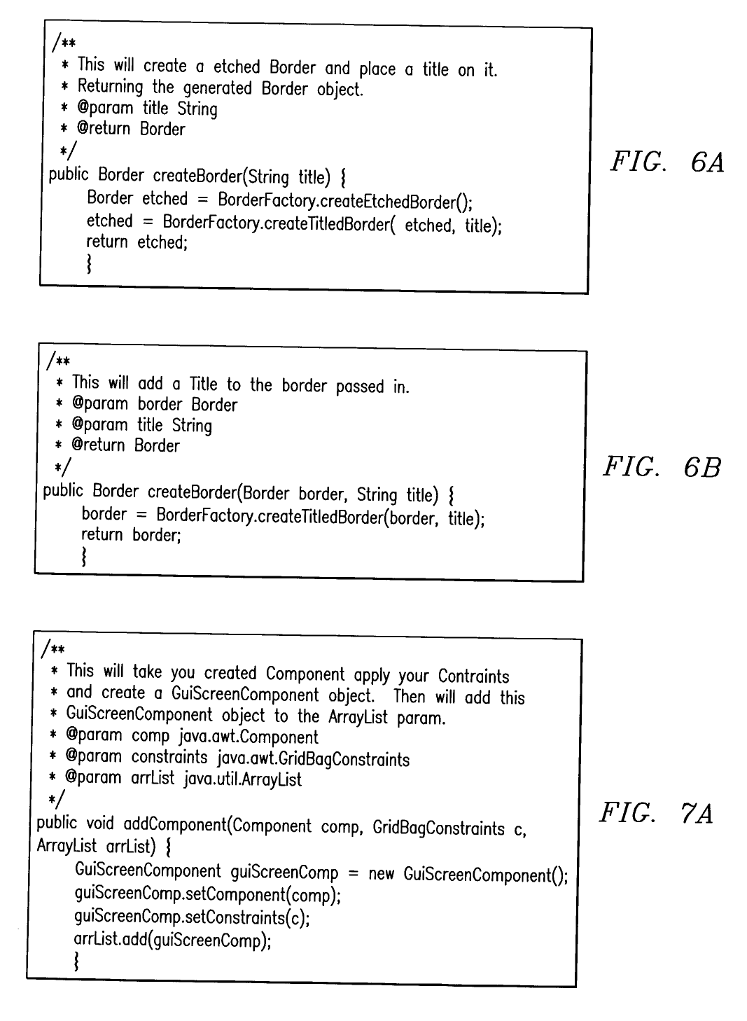

FIGS. 6A and 6B depict example code for creating a border in accordance with a preferred embodiment of the present invention. The createBorder method creates an etched border that may include a title string. The method receives a title string as a parameter and returns the border component object. The method may also receive a border component object and a title string as parameters to apply a title string to an existing border component object.

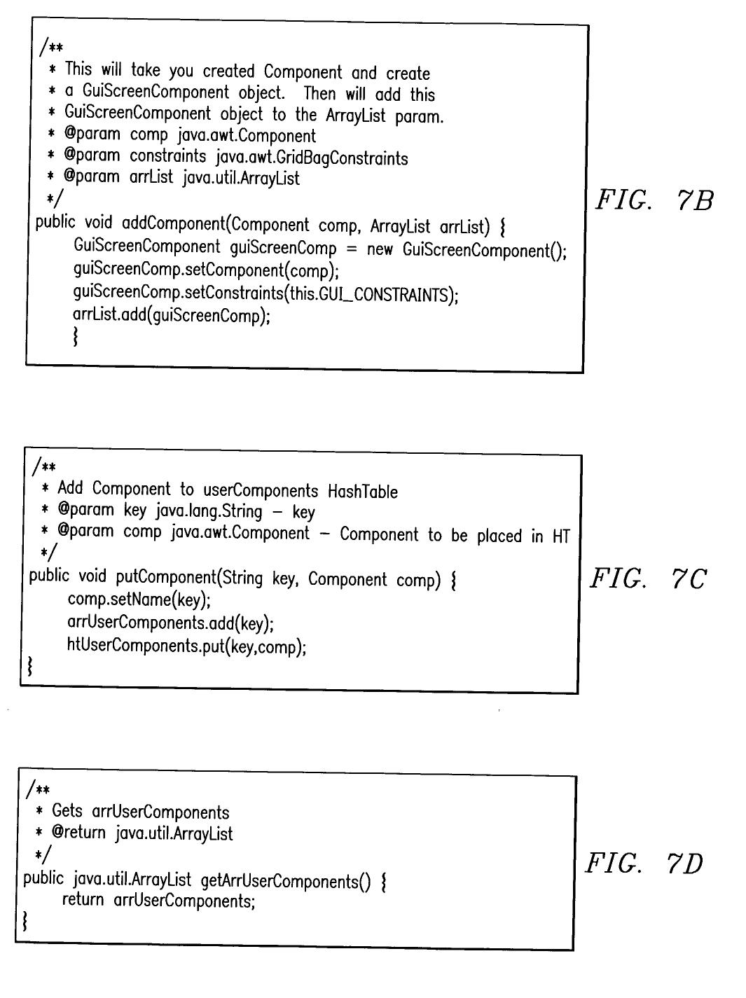

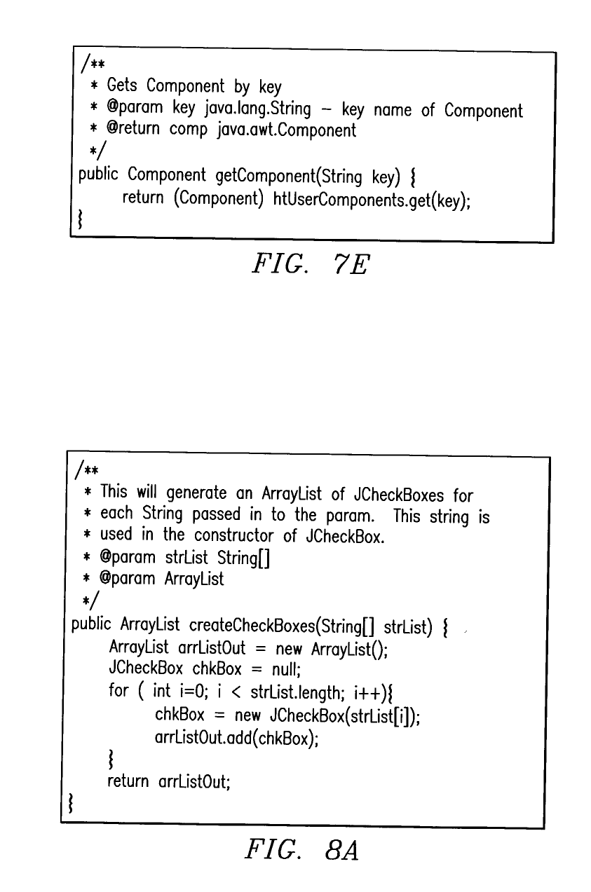

FIGS. 7A-7E depict example code for using an array list of components or a hash table in accordance with a preferred embodiment of the present invention. The addComponent method receives a component and an array list of components as parameters. The method then adds the component to the array list and returns the array list of components. The method may also receive as a parameter a plurality of constraints and apply those constraints to the array list of components. The putComponent method takes a key name string and a component as parameters and puts the component into a hash table using the key name. The getArrUserComponents returns the array of user components. The getComponent method receives a key name for a component and returns the component object corresponding to the specified key name from a user hash table.

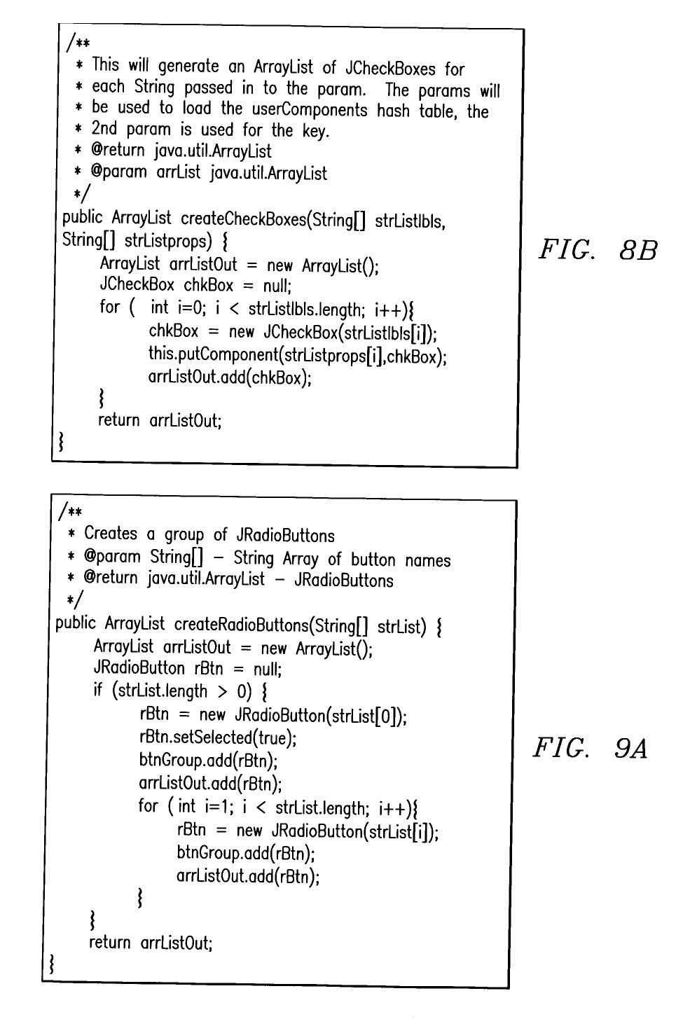

FIGS. 8A and 8B depict example code for generating check boxes in accordance with a preferred embodiment of the present invention. The createCheckBoxes method receives as a parameter a string list and creates a check box for each string in the list. The method then creates an array list of check box objects. A Swing check box object is referred to as a “JCheckBox.” The createCheckBoxes method may also create an array list of check boxes using a user hash table.

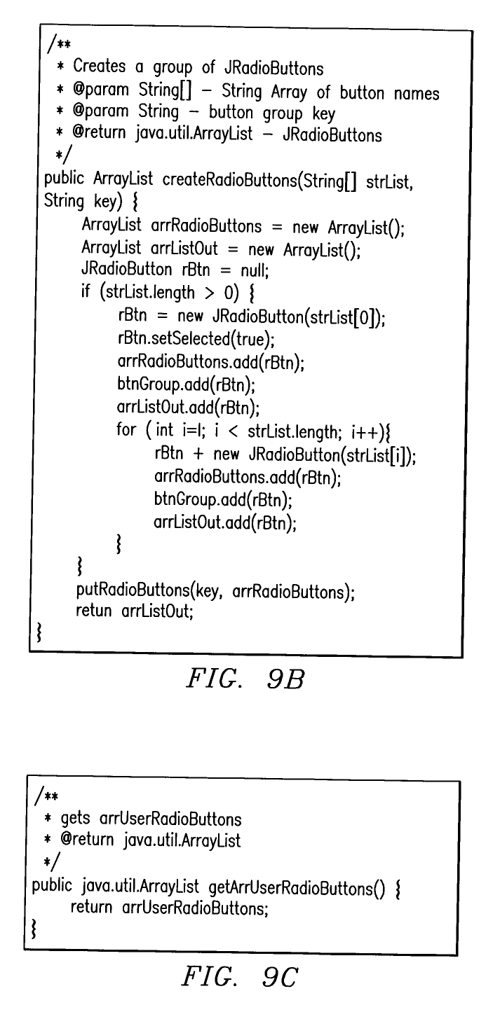

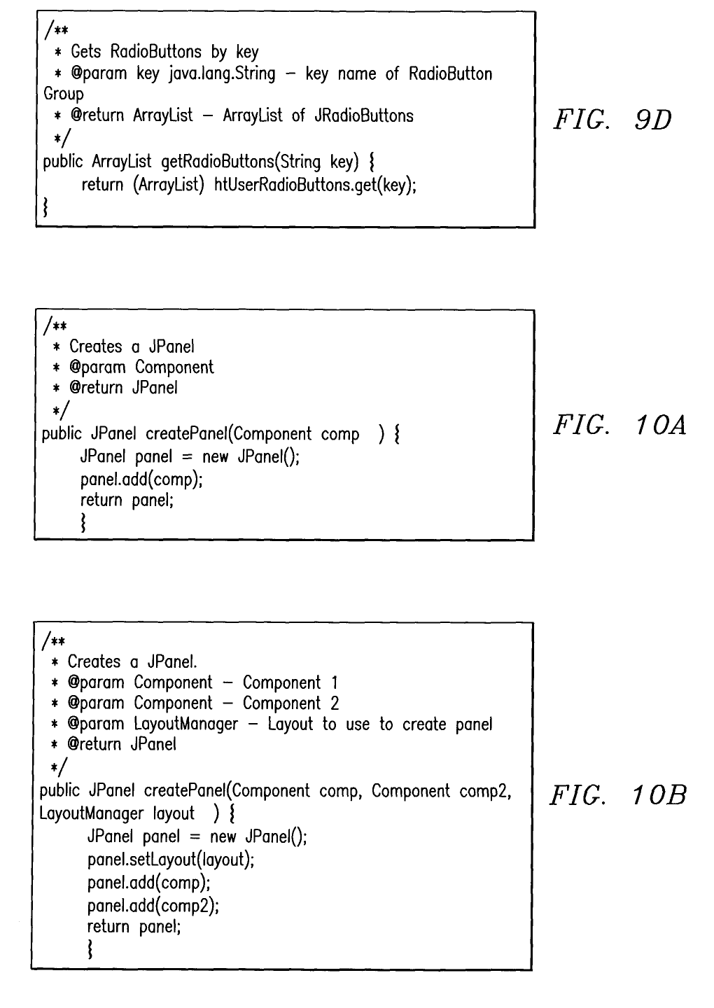

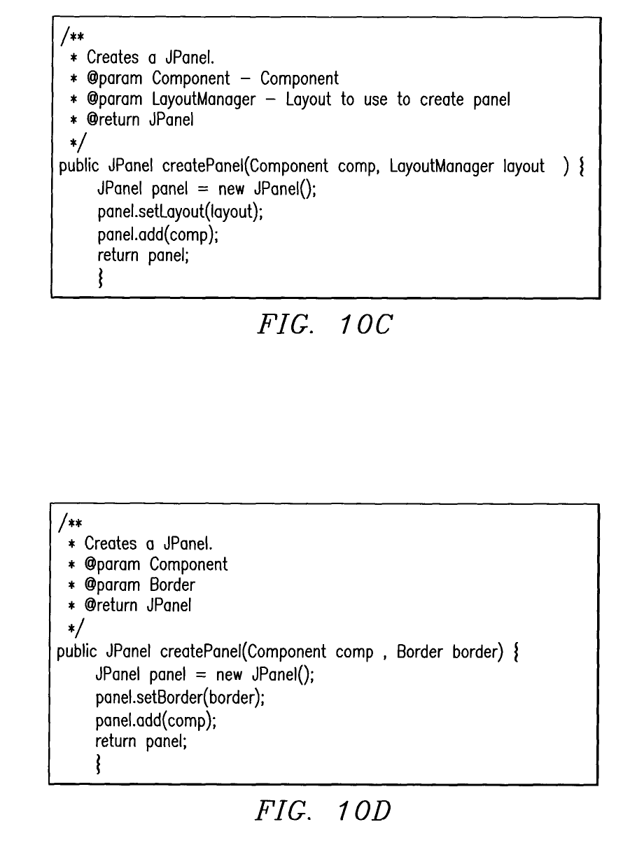

FIGS. 9A-9D illustrate example code for creating a group of radio buttons in accordance with a preferred embodiment of the present invention. The createRadioButtons method receives a string list of radio button names and returns an array of radio button objects. A Swing radio button object is referred to as a “JRadioButton.” The createRadioButtons method may also create an array of radio buttons using a user hash table. The getArrUserRadioButtons method returns the array of user radio buttons. The getRadioButtons method receives a key name as a parameter and returns the radio button corresponding to the specified key name.

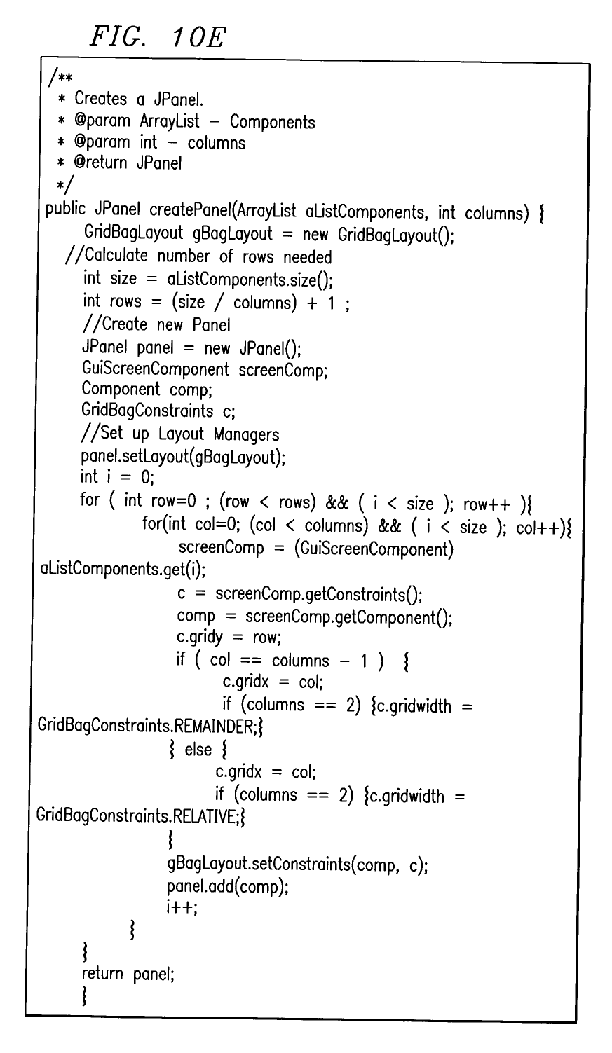

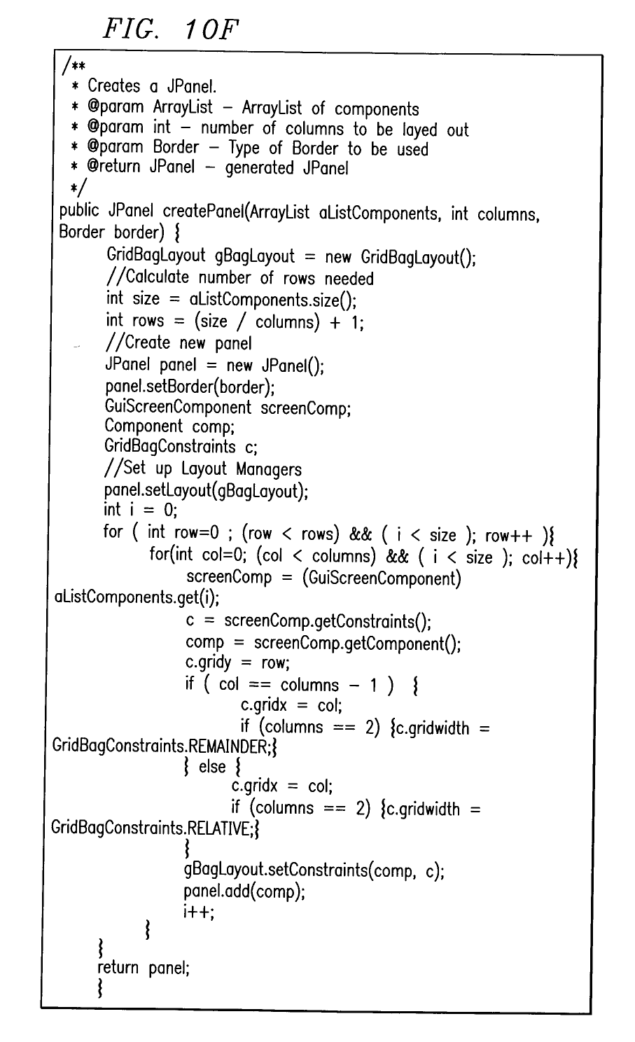

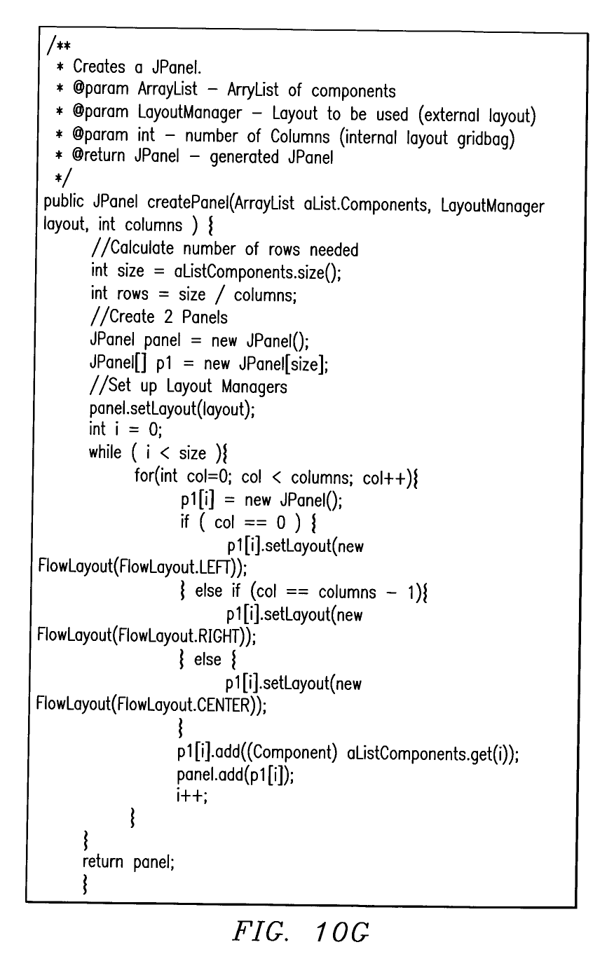

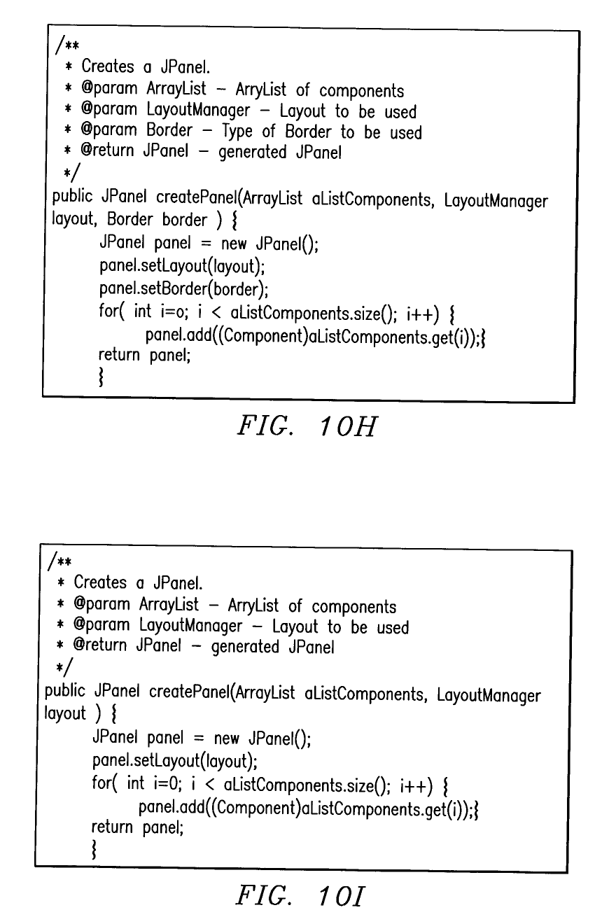

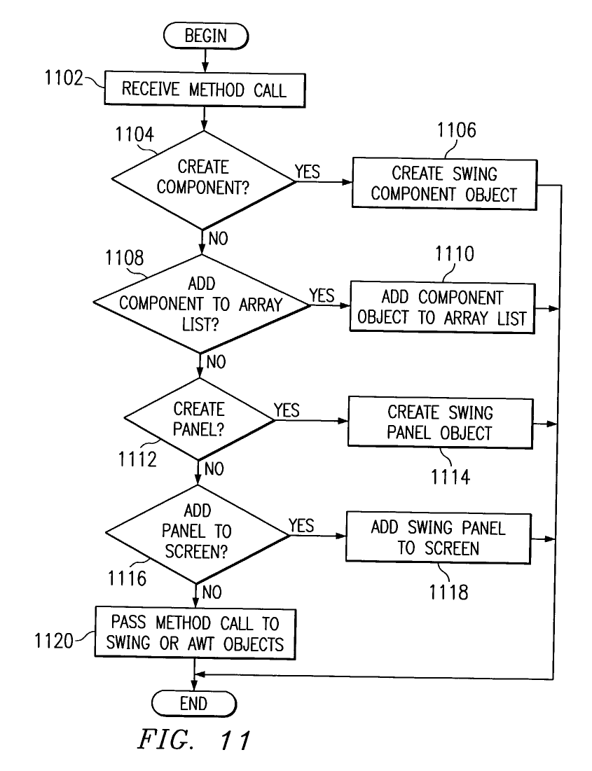

Figures 10A-10I illustrate example code for creating a screen panel in accordance with a preferred embodiment of the present invention. The method may receive a component, a plurality of components, or an array of component objects. The method returns a screen panel. A Swing panel object is referred to as a “JPanel.”

The createPanel method may also receive as a layout manager as a parameter. A layout manager is a tool included in the JRE for configuring components in a screen. This is especially helpful when a screen is moved, resized, or maximized. A default layout manager may be used by the GUI toolkit. However, by allowing a developer to specify a layout manager to exercise more control over the generation of the screen. The method may also receive a border object to apply to the panel.

In addition, the createPanel method may receive an array list of components and a number of columns as parameters. The method will arrange components into the specified number of columns in the panel. Various combinations of parameters may be received by the createPanel method. For example, the method may receive an array list of components, a number of columns, and a border. The method may also receive an array list of components, a number of columns, and a layout manager.

The GUI toolkit may also include support methods. More particularly, the GUI toolkit class may include a setMaxIntLen method, a setMaxLen method, and a setUpperCase method.

The setMaxlntLen method sets a restraint on text entered into a text field. Only integer data can be entered and is limited to the defined iMaxLen parameter. Example code for the setMaxLen method is as follows:

/**

* setMaxIntLen(int iMaxLen)
* Sets a restraint on text entered in to a text field.
* Only integer data can be entered and is limited
* to the defined iMaxLen parameter.
* @ return com.common.swing.LimitedStyleDocument
* @ param iMaxLen int
*/

public LimitedStyleDocument setMaxIntLen(int iMaxLen) {

return (new IntegerLimitedStyleDocument (iMaxLen) );

}

The setMaxLen method sets a restraint on text entered into a text field. Any string data can be entered and is limited to the defined iMaxLen parameter. Example code for the setMaxLen method is as follows:

/**

* setMaxLen(int iMaxLen)
* Sets a restraint on text entered in to a text field.
* Any String data can be entered and is limited
* to the defined iMaxLen parameter.
* @ return com.common.swing.LimitedStyleDocument
* @ param iMaxLen int
*/

public LimitedStyleDocument setMaxLen(int iMaxLen) {

return (new LimitedStyleDocument (iMaxLen) );

}

The setUpperCase method sets a restraint on text entered into a text field. Any string data can be entered and is limited to the defined iMaxLen parameter. In addition, all entered text is set to upper case. Example code for the setUpperCase method is as follows:

/**

* setUpperCaseCint iMaxLen)
* Sets a restraint on text entered into a text field.
* Any String data can be entered and is limited
* to the defined iMaxLen parameter. Plus all entered
* text is set to Uppercase.
* @ return com.comn-ion.swing.LimitedStyleDocument
* @ param iMaxLen int
*/

public UpperCaseLimitedStyleDocument setUpperCase (int
iMaxLen) {

return (new

UpperCaseLimitedStyleDocument (iMaxLen) );
}

FIGS. 6A and 6B, FIG. 7A-7E, FIG. 8A and 8B, FIGS. 9A-9D, and FIGS. 10A-10I, and the example code for the supporting methods, are intended as examples. These figures and the example code are not intended to limit the present invention. The functionality of the depicted methods may be achieved using different code. Furthermore, more or fewer methods may be included in the GUI toolkit and other screen components may be generated within the scope of the present invention.

With reference to FIG. 11, a flowchart illustrating the operation of the GUI toolkit receiving a method call is shown in accordance with the preferred embodiment of the present invention. The process begins and receives a method call (step 1102). A determination is made as to whether the method call is to a method for creating a component object (step 1104). If the call is to a method for creating a component object, the process creates the Swing component object (step 1106) and ends. The GUI toolkit may create other screen objects, such as by using AWT objects.

If the call is not a call to a method for creating a component object in step 1104, a determination is made as to whether the call is to a method for adding a component to an array list (step 1108). If the call is to a method for adding a component to an array list, the process adds the component to the specified array list (step 1110) and ends.

If the call is not a call to a method for adding a component to an array list in step 1108, a determination is made as to whether the call is to a method for creating a panel (step 1112). If the call is to a method for creating a panel, the process creates a Swing panel object (step 1114) and ends.

If the call is not to a method for creating a panel in step 1112, a determination is made as to whether the call is to a method for adding a panel to a screen (step 1116). If the call is to a method for adding a panel to a screen, the process adds the Swing panel to the specified screen (step 1118) and ends. Otherwise, the process passes the method call to the Swing or AWT objects or other appropriate objects in the JRE (step 1120) and ends.

Thus, the present invention solves the disadvantages of the prior art by providing a GUI toolkit that may be used to generate Swing and other screen objects. The GUI toolkit gives developers a plurality of screen generation methods and prebuild instance variables that help with the creation of graphical user interface screens. The toolkit contains methods to store screen components by key, which allows and easy way to set information in each screen. When an application class inherits the toolkit, these screen generation methods may be used to more quickly and easily generate graphical user interface screens.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for generating display screens in a data processing system comprising:
providing a graphical user interface toolkit class, wherein the graphical user interface toolkit class inherits a Swing class and includes a plurality of toolkit methods;
receiving a method call from an application;
determining whether the method call is for one of the plurality of toolkit methods; and
if the method call is for one of the plurality of toolkit methods, executing the corresponding toolkit method, wherein the toolkit method calls a Swing method in the Swing class.

2. The method of claim 1, wherein the corresponding toolkit method comprises instructions for creating a screen component object.

3. The method of claim 2, wherein the screen component object comprises one of a border, a check box, a radio button, and a panel.

4. The method of claim 1, wherein the corresponding toolkit method comprises instructions for creating an array of screen component objects.

5. The method of claim 4, wherein the screen component objects comprise one of check boxes and radio buttons.

6. The method of claim 1, wherein the corresponding method comprises instructions for adding a component object to an array list of components.

7. The method of claim 1, wherein the corresponding method comprises instructions for adding a component object to a user hash table.

8. The method of claim 1, wherein the corresponding method comprises instructions for getting a component object from a user hash table by key name.

9. The method of claim 1, further comprising:
if the method call is not for one of the plurality of toolkit methods, determining whether the method call is for a Swing method in the Swing class; and
if the method call is for a Swing method in the Swing class, executing the Swing method directly.

10. The method of claim 1, wherein the graphical user interface toolkit class inherits an Abstract Window Toolkit class and wherein the toolkit method calls an Abstract Window Toolkit method in the Abstract Window Toolkit class.

11. The method of claim 1, further comprising:
generating a Swing component object by calling the Swing method via the toolkit method.

12. An apparatus for generating display screens in a data processing system comprising:
means for providing a graphical user interface toolkit class, wherein the graphical user interface toolkit class inherits a Swing class and includes a plurality of toolkit methods;
means for receiving a method call from an application;
means for determining whether the method call is for one of the plurality of toolkit methods; and
means, responsive to the method call being for one of the plurality of toolkit methods, for executing the corresponding toolkit method, wherein the toolkit method calls a Swing method in the Swing class.

13. A computer program product, in a computer readable medium, for generating display screens in a data processing system comprising:
instructions for providing a graphical user interface toolkit class, wherein the graphical user interface toolkit class inherits a Swing class and includes a plurality of toolkit methods;
instructions for receiving a method call from an application;
instructions for determining whether the method call is for one of the plurality of toolkit methods; and
instructions, responsive to the method call being for one of the plurality of toolkit methods, for executing the corresponding toolkit method, wherein the toolkit method calls a Swing method in the Swing class.

14. The computer program product of claim 13, wherein the corresponding toolkit method comprises instructions for creating a screen component object.

15. The computer program product of claim 14, wherein the screen component object comprises one of a border, a check box, a radio button, and a panel.

16. The computer program product of claim 13, wherein the corresponding toolkit method comprises instructions for creating an array of screen component objects.

17. The computer program product of claim 16, wherein the screen component objects comprise one of check boxes and radio buttons.

18. The computer program product of claim 13, wherein the corresponding method comprises instructions for adding a component object to an array list of components.

19. The computer program product of claim 13, wherein the corresponding method comprises instructions for adding a component object to a user hash table.

20. The computer program product of claim 13, wherein the corresponding method comprises instructions for getting a component object from a user hash table by key name.

21. The computer program product of claim 13, further comprising:
instructions, responsive to the method call not being for one of the plurality of toolkit methods, for determining whether the method call is for a Swing method in the Swing class; and
instructions, responsive to the method call being for a Swing method in the Swing class, for executing the Swing method directly.

22. The computer program product of claim 13, wherein the graphical user interface toolkit class inherits an Abstract Window Toolkit class and wherein the toolkit method calls an Abstract Window Toolkit method in the Abstract Window Toolkit class.

23. The computer program product of claim 13, further comprising:
instructions for generating a Swing component object by calling the Swing method via the toolkit method.
